(19) United States
(12) Patent Application Publication
(10) Pub. No.: US 2006/0014570 A1
(43) Pub. Date: Jan. 19, 2006

(54) Mobile communication terminal

(76) Inventors: Jochen Marx, Ulm (DE); Thomas Goggelmann, Gerstetten (DE)

Correspondence Address: PERMAN & GREEN, 425 POST ROAD, FAIRFIELD, CT, 06824, US

(21) Appl. No.: 10/519,435

(22) PCT Filed: Jul. 1, 2002
(86) PCT No.: PCT/EP02/07228

§ 371 Date: Aug. 12, 2005

(51) Int. Cl. H04M 1/00

(52) U.S. Cl. 455/569.1

(57) ABSTRACT

The invention relates to controlling the equalizer in a mobile communication terminal, advantageously a mobile phone. According to the invention, the communication terminal includes means for decreasing the frequency selective attenuation by the equalizer when a maximum amplification by the amplifier has already been reached in order to increase the volume of the sound reproduced by the loudspeaker.

The present invention relates to mobile communication terminals comprising a loudspeaker with a non-flat frequency response, an amplifier and an equalizer for at least partially compensating the non-flat frequency response of said loudspeaker through frequency selective attenuation. Further, the invention relates to a sound reproduction system for a mobile communication terminal comprising a loudspeaker with a non-flat frequency response, an amplifier and an equalizer for at least partially compensating the non-flat frequency response of said loudspeaker through frequency selective attenuation, and to a method of controlling the volume of the sound produced by an audio system for a mobile communication terminal.

### BACKGROUND ART

Mobile communication terminals need to provide a reasonable good audio quality from the in build loudspeaker. Especially, mobile communication terminals provided with e.g. a FM radio, a digital audio player or hands free speaker function, need to provide a good audio quality. Ideally a loudspeaker would make all notes in the frequency range sound as loud as each other. In other words, it would have a flat frequency response. This is practically impossible from a single loudspeaker because of resonance. Mobile communication terminals, such as mobile phones are typically equipped with only one loudspeaker and have a further disadvantage in that the single loudspeaker is not placed in a dedicated loudspeaker cabinet. Instead, the housing of the mobile phone serves amongst many other functions as a loudspeaker cabinet. Another requirement on the audio system is the ability to produce loud alarms and ringing tones. Obviously, many compromises have to be made in the choice of loudspeaker and in designing the housing. The resulting frequency response is therefore usually not linear. The audio system of some mobile phones is equipped with an equalizer to compensate as far as possible for the loudspeaker characteristic such as to obtain a more linear frequency response, i.e. by dampening out the resonance frequencies, especially in the critical midrange frequencies to which human hearing is most attuned.

EP-A-0 767 570 discloses a mobile communication terminal in which the equalization of a reproduced sound is changed according to the operating conditions of the terminal. Information about the conditions is obtained by monitoring the sound volume set by the user, measuring the background noise in the operating environment of the phone through the phone's microphone and/or monitoring the quality of the connection between the phone and the communication network. The low frequency emphasis is reduced in a very noisy environment and increased in a quiet environment. It is required that the terminal handles sound as a digital-form signal. The terminal includes therefore a loudspeaker for sound reproduction and a digital signal processing means for digital processing of the sound to be reproduced, which digital signal processing means comprises an equalizer with a certain frequency response, means for generating control information describing its operating conditions and a means for changing the frequency response of the equalizer on the basis of the control information.

U.S. Pat. No. 5,915,235 discloses a mobile communication terminal comprising an equalizer preprocessor for a mobile telephone speech coder that adapts to the characteristics of its input transducer. The equalizer determines the frequency response of the input transducer by measuring the long term characteristics of the input signal and estimating the spectral envelope of that signal. The equalizer then adapts so that the output signal has a spectral response closer to a perceptually ideal response in accordance with the calculated spectral envelope.

WO-A-9 805 150 discloses a cellular having an audio speaker provided with means for receiving audio signals and means for filtering the audio signals to alter a frequency response pattern thereof. The means for filtering operates in response to user control to allow the user to adjust the frequency response pattern as desired. In this manner, the user may adjust the frequency response to compensate for local noise or transmission problems or for hearing abnormalities to thereby allow the user to hear the other party to a telephone call more clearly.

None of the prior art mobile communication terminals has though provided a satisfactory solution to fulfill both the requirement of an optimum frequency response characteristic and a high obtainable maximum volume.

### DISCLOSURE OF THE INVENTION

On this background, it is an object of the present invention to provide a mobile communication terminal of the kind referred to initially, which provides both a good frequency response and a high maximum obtainable volume. This object is achieved in accordance with claim 1 by providing a terminal of said kind that comprises means for decreasing the frequency selective attenuation to increase the volume of the sound reproduced by the loudspeaker when a maximum amplification by the amplifier has already been reached. Thus, in the situation where further amplification is not possible, which in the prior art solutions meant that no higher volume could be obtained, a further increase in volume is possible by gradually eliminating the frequency selective attenuation by the equalizer. This additional volume is particularly advantageous for loud reproduction speech signals, since the typical loudspeaker frequency response is such that the frequency selective attenuation by the equalizer is highest in the mid-range frequencies that are important for the intelligibility of speech. Thus, reducing the frequency selective attenuation increases the volume in the mid-range frequencies, and the intelligibility of the speech signal reproduced is improved in e.g. loud ambient noise conditions.

The frequency selective attenuation can be decreased by decreasing the attenuation for all frequencies reproduced, or by changing the characteristic of the equalizer.

Advantageously, the means for decreasing the frequency selective attenuation are set to obtain substantially zero attenuation of all frequencies reproduced at a maximum volume setting, so that a minimum loss maximum volume sound can be reproduced.

The mobile communication terminal may further comprise means for adjusting the amplification level of the amplifier that are arranged to maintain the amplification at a maximum level when the volume setting is reduced until the means for decreasing the frequency selective attenuation has increased the attenuation factor to a level at which a substantially linear frequency response of said loudspeaker is obtained.

The mobile communication terminal may comprise means for adjusting the amount of frequency selective attenuation that are arranged to adapt the profile of the frequency response of the loudspeaker system increasingly to the hearing curve of the human ear, preferably as defined in ISO 226:1987, with decreasing volume setting.

It is another object of the present invention to provide a mobile communication terminal of the kind referred to initially, which provides both a good frequency response and a high intelligibility of the sound reproduced. This object is achieved in accordance with claim 8 by providing a terminal of said kind that comprises means for adjusting the frequency selective attenuation to increasingly adapt the frequency response of said loudspeaker to the human hearing curve with decreasing volume setting.

It is yet another object of the present invention to provide a sound reproduction system for a mobile communication terminal comprising a loudspeaker with a non-flat frequency response, an amplifier and an equalizer for at least partially compensating the non-flat frequency response of said loudspeaker through frequency selective attenuation, which provides for an optimized frequency response and obtainable volume for different types of signals to be reproduced. This object is achieved in accordance with claim 11 by providing a sound reproduction system of said kind comprising means for adjusting the frequency response characteristic of the equalizer depending on the type of audio signal reproduced.

The type of audio signals may comprise speech signals, music signals, ringing tones and alarms. Speech signal may further be divided into speech signals for headset use and speech signals of hands free use (speakerphone).

The sound reproduction system may comprise means for automatically adjusting the frequency response of the equalizer when a speech signal is reproduced to obtain a substantially flat frequency response of the loudspeaker to increase intelligibility at higher volume settings.

The sound reproduction system may further comprise means for automatically adjusting the frequency response of said equalizer when a speech signal is reproduced to obtain a frequency response of said loudspeaker that substantially corresponds to normal equal-loudness level contours as defined in ISO 226:1987, to improve intelligibility.

The sound reproduction system may also comprise means for automatically adjusting the frequency response of the equalizer when a music signal is reproduced to obtain a low attenuation of the low-frequency part of the sound reproduced, to place more emphasis on the low-frequency part of the music reproduced, which is often advantageous in reproduction of music.

The sound reproduction system may also comprise means for automatically adjusting the frequency response of the equalizer when a music signal is reproduced to obtain a high attenuation of mid-frequency part of the sound reproduced, so that more emphasis is placed on the low-frequency and high-frequency part of the music reproduced, which is often advantageous in reproduction of music.

The sound reproduction system may also comprise means for automatically adjusting the frequency response of the equalizer when a ringing signal or an alarm signal is reproduced to a substantially zero attenuation of all frequencies of the sound reproduced, so that ringing tones and alarms can be reproduced as loud as possible.

It is another object of the present invention to provide a method of controlling the volume of sound produced by an audio system for a mobile communication terminal of the kind referred to initially. This object is achieved in accordance with claim 18 by providing a method comprising the steps of:
increasing the amplification of the audio signal when input for increasing the volume is received and a maximum amplification has not yet been reached,
decreasing the frequency selective attenuation of the equalizer when input for increasing the volume is received and the maximum amplification has already been reached,
increasing the frequency selective attenuation of the equalizer when input for decreasing the volume is received and the frequency selective attenuation is below the normal level, and
decreasing the amplification of the audio signal when input for decreasing the perceived loudness is received and the attenuation level of the equalizer is on the normal level.

Further objects, features, advantages and properties of the mobile communication terminal, sound reproduction system and method according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 is a graph showing various the frequency responses of a loudspeaker of a mobile phone,

FIG. 2 is a block diagram illustration principle of the invention and its application in a mobile phone, and

FIG. 3 is a graph showing the various frequency selective attenuation profiles of the equalizer.

### DETAILED DESCRIPTION

In the following detailed description, a mobile communication terminal according to the invention in the form of a hand portable phone, preferably a cellular/mobile phone, will be described by the preferred embodiments.

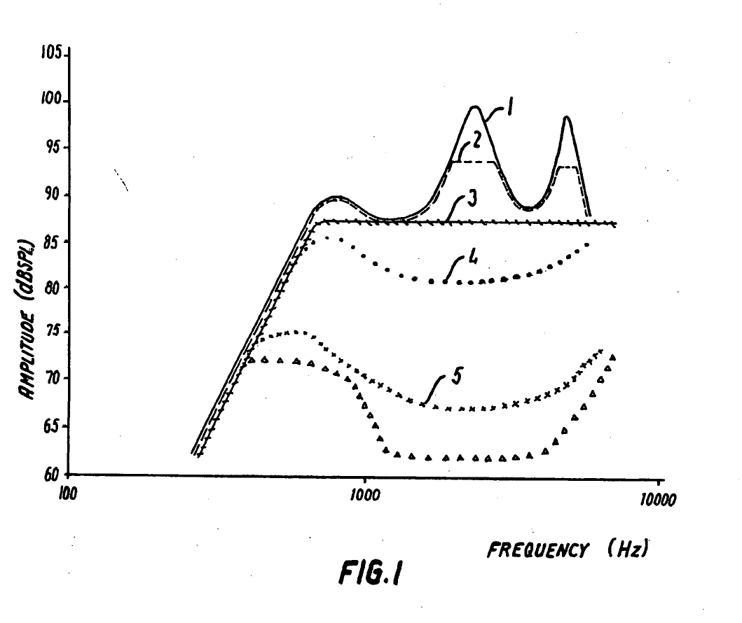

The continues line 1 in FIG. 1 shows the frequency response of the loudspeaker 14 of the mobile phone, when no equalization is used. The graph clearly shows two resonance peaks, characteristic for a single loudspeaker design.

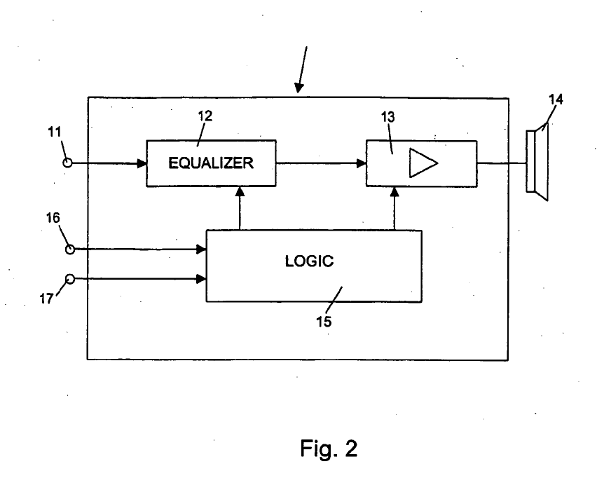

The mobile phone comprises a digital signal processor, responsible for the digital processing of a speech or music signal in the mobile phone. The digital signal is converted to an analog signal and fed to the analog signal processor 10. FIG. 2 shows a block diagram of the analog signal processor 10. The analog signal is received at terminal 11. The signal passes from the terminal 11 via an equalizer 12 and an amplifier 13 to a loudspeaker 14. Alternatively, the signal processor 10 can be digital and in this case the equalizer 12 is fed with a digital signal, which means that the equalizer 12 includes or is followed by a D/A converter. In the lower part of the figure, a control unit 15, the main task of which, is to control the equalizer 12, so that the signal to be reproduced is frequency selectively attenuated. Another task of the control unit 15 is to control the amplification by amplifier 13. The operation of the control block 15 is based on control parameters which are brought to the control block as input signals. The control block receives a signal identifying the type of audio signal to be represented from terminal 16. The type of signals to be reproduced comprise speech signals, speech signals for use with a headset, speech signals for use with a loudspeaker, music signals, ringing tones and alarms. From terminal 17 the control block receives a signal indicating the volume setting. The volume setting could be provided by the user trough the user interface, or be provided automatically, i.e. in response to measured or received signals. On the basis of the type of audio signal and the volume setting, the control unit 15 is able to retrieve the desired setting for the frequency selective attenuation of the equalizer 12 and the desired amplifier setting from a look-up table stored in the control unit 15. The frequency selective attenuation of the equalizer 12 is chosen such that the frequency response of the loudspeaker 14 is adapted to the different circumstances at which the mobile phone operates. The frequency selective attenuation of the equalizer can vary in many ways. The different settings are explained with the following examples.

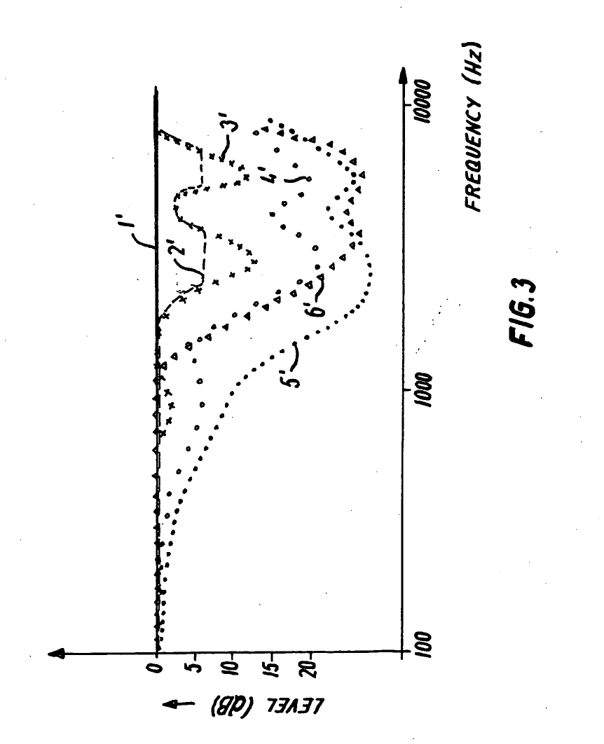

When the control unit 15 receives from terminal 16 a signal that a ringing tone of an alarm is to be reproduced, the frequency response of the loudspeaker 14 is substantially flat, as shown by line 3 in FIG. 1. The frequency selective attenuation of the equalizer 12 for the corresponding setting is shown in FIG. 3 by line 1′. The frequency selective attenuation of the equalizer 12 is set to obtain a substantially flat loudspeaker response for all volume settings between the lowest volume setting and a high volume setting, at which the amplifier setting is at its maximum. The volume is change takes place through adjustment of the setting of the amplifier 13 only.

For volume settings there above the setting at which the maximum amplification is reached, the frequency selective attenuation of the equalizer 12 is reduced. The setting for the amplifier 13 is maintained at the maximum amplification. The interrupted line 2 in FIG. 1 shows the corresponding frequency response of the loudspeaker 14. The frequency selective attenuation of the equalizer for the corresponding setting is shown in FIG. 3 by line 2′. For volume settings between the setting at which the maximum amplification setting for the amplifier 13 is reached and the absolute maximum volume setting, the frequency selective attenuation of the equalizer 12 is gradually reduced from the setting as shown by line 3′ via the setting as shown by line 2′ to the setting as shown by lime 1′ at which no frequency selective attenuation of the equalizer 12 takes place (zero attenuation).

When the control unit 15 receives from terminal 16 a signal that a speech signal is to be reproduced, the frequency response of the loudspeaker 14 is substantially flat, as shown by line 3 in FIG. 1, for a high volume setting only. The frequency selective attenuation of the equalizer 12 for the high volume setting is shown in FIG. 3 by line 3′. The human hearing response is not equally sensitive to all frequencies, particularly in the low and high frequency ranges. For lower volume settings the response of the loudspeaker 14 is therefore adjusted to the hearing curve of the human ear, preferably in an increasing manner in response to decreasing volume settings, and the volume is adjusted by adjusting the amplification. The loudspeaker response is preferably adjusted to the hearing curve as described by the equal loudness contours as defined in ISO recommendation 226:1987. The corresponding frequency responses of the loudspeaker are illustrated by lines 4 and 5 in FIG. 1. The frequency selective attenuation of the equalizer for the corresponding settings is shown in FIG. 3 by line 4′ and 5′. For volume settings above the setting at which the maximum amplification is reached, the frequency selective attenuation of the equalizer 12 is reduced as explained above.

When the control unit 15 receives from terminal 16 a signal that a music signal is to be reproduced, the frequency response of the loudspeaker 12 is adapted to emphasize the low-frequency part of the sound to be reproduced, and preferably also the high frequency part of the sound to be reproduced, as illustrated by line 6 in FIG. 1. The frequency selective attenuation of the equalizer 12 for the corresponding setting is shown in FIG. 3 by line 61. This setting allows improved reproduction of music signals, where for which a dominant mid-range response is advantageous.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the scope of the appended claims.

1. A mobile communication terminal comprising a loudspeaker with a non-flat frequency response, an amplifier and an equalizer for at least partially compensating the non-flat frequency response of said loudspeaker through frequency selective attenuation, characterized by comprising means for decreasing said frequency selective attenuation to increase the volume of the sound reproduced by said loudspeaker when a maximum amplification by said amplifier has already been reached.

2. A mobile communication terminal according to claim 1, characterized in that said frequency selective attenuation is decreased by decreasing the attenuation for all frequencies reproduced.

3. A mobile communication terminal according to claim 1, characterized in that said frequency selective attenuation is decreased by changing the characteristic of said equalizer.

4. A mobile communication terminal according to claim 2, characterized in that said means for decreasing said frequency selective attenuation are arranged to gradually decrease said frequency selective attenuation with increasing volume setting.

5. A mobile communication terminal according to claim 4, characterized in that said means for decreasing said frequency selective attenuation are set to obtain substantially zero attenuation of all frequencies reproduced at a maximum volume setting.

6. A mobile communication terminal according to claim 4, characterized by comprising means for adjusting the amplification level of said means for amplifying, said means for adjusting the amplification level being arranged to maintain the amplification at a maximum level when said volume setting is reduced until said means for decreasing said frequency selective attenuation has increased the attenuation factor to a level at which a substantially linear frequency response of said loudspeaker is obtained.

7. A mobile communication terminal according to claim 3, characterized in that said means for adjusting the amount of said frequency selective attenuation are arranged to adapt the profile of the frequency response of the loudspeaker system increasingly to the hearing curve of the human ear, preferably as defined in ISO 226:1987, with decreasing volume setting.

8. A mobile communication terminal comprising a loudspeaker with a non-flat frequency response, an amplifier and an equalizer for at least partially compensating the non-flat frequency response of said loudspeaker through frequency selective attenuation, characterized in that said audio system comprises means for adjusting said frequency selective attenuation to increasingly adapt the frequency response of said loudspeaker to the human hearing curve with decreasing volume setting.

9. A mobile communication terminal according to claim 8, characterized in that said means for adjusting said frequency selective attenuation increasingly adapt the frequency response of said loudspeaker to normal equal-loudness level contours as defined in ISO 226:1987 with decreasing volume setting.

10. A mobile communication terminal according to claim 8, characterized by comprising means for decreasing said frequency selective attenuation to increase the volume of the sound reproduced by said loudspeaker when a maximum amplification by said amplifier has already been reached.

11. A sound reproduction system for a mobile communication terminal comprising a loudspeaker with a non-flat frequency response, an amplifier and an equalizer for at least partially compensating the non-flat frequency response of said loudspeaker through frequency selective attenuation, characterized in that said audio system comprises means for adjusting the frequency response characteristic of said equalizer depending on the type of audio signal reproduced.

12. A sound reproduction system according to claim 11, characterized in that said type of audio signals comprise speech signals, speech signals for use with a headset, speech signals for use with a loudspeaker, music signals, ringing tones and alarms.

13. A sound reproduction system according to claim 11, characterized by comprising means for automatically adjusting the frequency response of said equalizer when a speech signal is reproduced to obtain a substantially flat frequency response of said loudspeaker.

14. A sound reproduction system according to claim 11, characterized by comprising means for automatically adjusting the frequency response of said equalizer when a speech signal is reproduced to obtain a frequency response of said loudspeaker that substantially corresponds to normal equal-loudness level contours as defined in ISO 226:1987.

15. A sound reproduction system according to claim 11, characterized by comprising means for automatically adjusting the frequency response of said equalizer when a music signal is reproduced to obtain a low attenuation of the low-frequency part of the sound reproduced.

16. A sound reproduction system according to claim 11, characterized by comprising means for automatically adjusting the frequency response of said equalizer when a music signal is reproduced to obtain a high attenuation of mid-frequency part of the sound reproduced.

17. A sound reproduction system according to claim 11, characterized by comprising means for automatically adjusting the frequency response of said equalizer when a ringing signal or an alarm signal is reproduced to a substantially zero attenuation of all frequencies of the sound reproduced.

18. A method of controlling the volume of sound produced by an audio system for a mobile communication terminal, said audio system comprising a loudspeaker with a non-flat frequency response, means for amplifying an audio signal, an equalizer for at least partially compensating the non-flat frequency response of said loudspeaker by frequency selective attenuation and input means allowing user input for increasing or decreasing the volume, comprising the steps of:
increasing the amplification of said audio signal when input for increasing the volume is received and a maximum amplification has not yet been reached,
decreasing the frequency selective attenuation of said equalizer when input for increasing the volume is received and the maximum amplification has already been reached,
increasing the frequency selective attenuation of said equalizer when input for decreasing the volume is received and the frequency selective attenuation is below said normal level, and
decreasing the amplification of said audio signal when input for decreasing the perceived loudness is received and the attenuation level of said equalizer is on said normal level.
